(19) United States
(12) Patent Application Publication
(10) Pub. No.: US 2023/0001434 A1
(43) Pub. Date: Jan. 5, 2023

(54) COATING LIQUID MIXING DEVICE, AND COATING LIQUID MIXING METHOD

(71) Applicant: Kawasaki Motors, Ltd., Akashi-Shi (JP)

(72) Inventors: Fumihiro NAKAGAWA, Akashi-Shi (JP); Hideki KAWAMOTO, Kobe-Shi (JP)

(73) Assignee: Kawasaki Motors, Ltd., Akashi-Shi (JP)

(21) Appl. No.: 17/756,326

(22) PCT Filed: Dec. 23, 2020
(86) PCT No.: PCT/JP2020/048203

§ 371 Date: May 23, 2022

(30) Foreign Application Priority Data
Dec. 23, 2019 (JP) 2019-231128

(51) Int. Cl. B05B 7/04; B05D 1/02; B05B 3/10

(52) U.S. Cl. CPC B05B 7/04; B05D 1/02; B05B 3/10

(57) ABSTRACT

A coating liquid mixing device includes a supply tube including flow paths through which respective coating liquids flow and which are distally open; and a mixing nozzle communicating with an outlet of the supply tube so that the coating liquids flowing through the flow paths are supplied to an interior space, and including a reduced diameter portion in which the interior space is reduced toward an outlet so that an open area of the mixing nozzle is smaller than a total open area of the flow paths.

### FIELD OF THE INVENTION

The present invention relates to technology of mixing coating liquids.

### BACKGROUND OF THE INVENTION

Patent Document 1 discloses that coating materials supplied from coating material feed tubes are mixed when passing through the interior of a static mixer disposed within a conduit.

### PRIOR ART DOCUMENT

### Patent Document

Patent Document 1: Japanese Patent Application Laid-Open No. 2000-153184

### SUMMARY OF THE INVENTION

### Problem to be Solved by the Invention

The static mixer disclosed in Patent Document 1 includes a baffle for agitation. In this technology, the baffle is likely to be clogged with materials contained in coating liquids.

The static mixer is thus cumbersome to clean, and has low maintainability.

It is thus an object of the present invention to provide a coating liquid mixing device having high maintainability.

### Means to Solve the Problem

To solve the above-mentioned problem, a coating liquid mixing device includes a supply tube including flow paths through which respective coating liquids flow and which are distally open; and a mixing nozzle communicating with an outlet of the supply tube so that the coating liquids flowing through the flow paths are supplied to an interior space, and including a reduced diameter portion in which the interior space is reduced toward an outlet so that an open area of the mixing nozzle is smaller than a total open area of the flow paths.

To solve the above-mentioned problem, a coating liquid mixing method includes: (a) a preparation step of preparing a supply tube and a mixing nozzle, the supply tube including flow paths through which respective coating liquids flow and which are distally open, the mixing nozzle communicating with an outlet of the supply tube so that the coating liquids flowing through the flow paths are supplied to an interior space, and including a reduced diameter portion in which the interior space is gradually reduced toward an outlet so that an open area of the mixing nozzle is smaller than a total open area of the flow paths; and (b) a supply step of supplying, after the preparation step, the coating liquids to the respective flow paths of the supply tube, and mixing the coating liquids from the outlet of the supply tube in the interior space of the mixing nozzle.

### Effects of the Invention

According to the above-mentioned coating liquid mixing device, the mixing nozzle has the interior space shaped to be reduced toward the outlet so that the open area of the mixing nozzle is smaller than the total open area of the flow paths. Thus, when the coating liquids are supplied from the respective flow paths to the mixing nozzle, the coating liquids are guided to be mixed together while increasing in flow velocity in the interior space of the mixing nozzle. By deflecting the coating liquids as described above, the coating liquids can be mixed together. By deflecting the coating liquids flowing through the nozzle for mixing as described above, a region where the coating liquids have a minimum flow velocity can be prevented compared with a case where the baffle for agitation is provided. Clogging of the nozzle with the coating liquids can thus be prevented. Maintainability can be improved due to reduction of work to eliminate clogging with the coating liquids.

According to the above-mentioned coating liquid mixing method, the above-mentioned mixing nozzle is prepared, and, in the supply step, the coating liquids are mixed using the mixing nozzle. Clogging of the nozzle with the coating liquids can thus be prevented to improve maintainability as described above.

### BRIEF DESCRIPTION OF DRAWINGS

FIG. 1 illustrates a coating liquid mixing device according to an embodiment.

FIG. 2 is a cross-sectional view taken along the line II-II of FIG. 1.

FIG. 3 illustrates a coating liquid mixing device according to a modification.

### DETAILED DESCRIPTION OF THE INVENTION

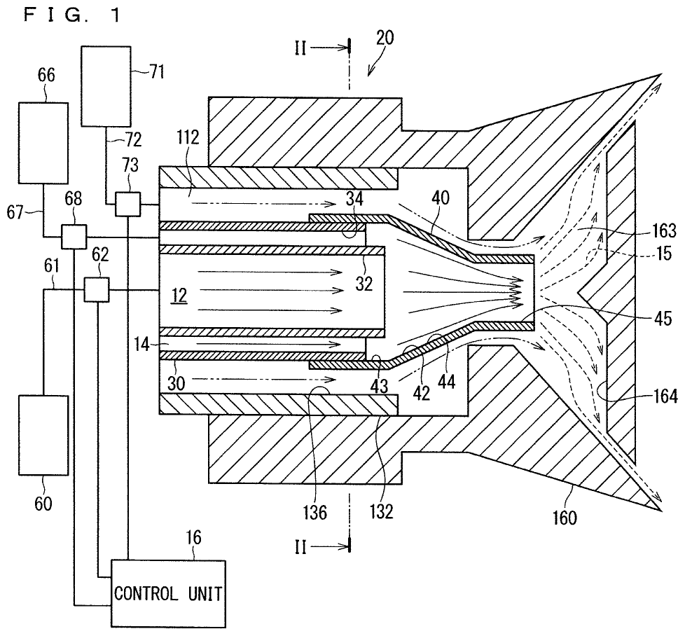

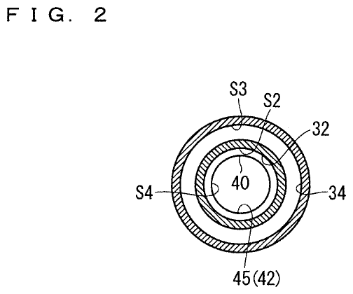

A coating liquid mixing device and a coating liquid mixing method according to an embodiment will be described below. FIG. 1 illustrates the coating liquid mixing device according to the embodiment. FIG. 2 is a cross-sectional view taken along the line II-II of FIG. 1.

A coating liquid mixing device 20 is a device to mix coating liquids. In the present embodiment, the coating liquid mixing device 20 is provided as a portion of a coating device, for example. Specifically, the coating liquid mixing device 20 is disposed at a location close to a jet of the coating device to eject the coating liquids. For example, the coating device includes a coating robotic device having a distal end movable to any location and orientation, an ejection device disposed at the distal end of the robotic device and ejecting the coating liquids, a supply device supplying the coating liquids from a storage tank storing the coating liquids to the ejection device, and a control device. The control device controls the robotic device, the ejection device, and the supply device.

The control device provides operating instructions to a robot, so that the robot can move the jet of the ejection device to a predetermined location and a predetermined orientation. The control device controls the ejection device and the supply device to eject a predetermined quantity of the coating liquids at a predetermined ejection time.

The coating device according to the present embodiment may include a bell cup 160 to micronize the coating liquids. The bell cup 160 forms a residence space 163 in which the coating liquids reside, and discharges the coating liquids residing in the residence space 163 radially outward by centrifugal force due to rotation. More particularly, the coating device includes a mixing nozzle 40 disposed upstream from the bell cup 160 and discharging the coating liquids to the residence space 163. The coating liquids discharged from the mixing nozzle 40 collide with a wall surface 164 disposed downstream in a direction of ejection in the residence space 163 of the bell cup 160. The bell cup 160 rotates around an ejection axis of the mixing nozzle 40 at a high speed. The coating liquids in the residence space 163 adhering to the bell cup 160 move radially outward by centrifugal force while rotating along with the bell cup 160. The coating liquids move along a wall surface of the bell cup 160, and are discharged out of the residence space 163 by centrifugal force through an opening S formed in the residence space 163. The coating liquids further move radially along the wall surface of the bell cup 160 in a thin-film form, change into a particle form at an edge of the bell cup 160, and are splashed radially outward from the bell cup 160. The splashed coating liquids are further atomized by an electrostatic effect, and move toward a coating target. The coating device according to the present embodiment sprays the atomized coating liquids onto the coating target as described above. For example, the coating device is used for exterior coating of a body of a vehicle, such as an automobile, a motorcycle, and a construction machine. The coating target may be an automotive part, an electronic device, a metal part, and the like.

The coating device according to the embodiment of the present invention mixes coating liquids, and supplies the mixed coating liquids to the residence space 163 of the bell cup 160. The coating device discharges a mixture 15 of a coating liquid to be a main agent to determine a color and a curing agent to cure the main agent to the residence space 163 of the bell cup 160. The mixture 15 is one example of a coating liquid. The main agent is selected as appropriate according to a required coating form (e.g., a coating color). A common curing agent may be used regardless of the required coating form (coating color). Known materials used as coating liquids can be used for the main agent and the curing agent.

The coating liquid mixing device 20 includes a supply tube 30 and the mixing nozzle 40. The supply tube 30 includes flow paths 32 and 34. A curing agent 12 and a main agent 14 are supplied from a proximal end of the supply tube 30. The curing agent 12 and the main agent 14 flow respectively through the flow path 32 and the flow path 34, and flow out of respective outlets. The mixing nozzle 40 communicates with an outlet of the supply tube 30. As described above, the curing agent 12 and the main agent 14 are mixed in the mixing nozzle 40, and flow out of an outlet of the mixing nozzle 40 toward the residence space 163 of the bell cup 160.

The supply tube 30 includes tubular flow paths. More specifically, the supply tube 30 includes, as the flow paths, a central flow path 32 and an annular flow path 34 to be an outer flow path. In the present embodiment, a coating liquid to be the main agent 14 is supplied to the annular flow path 34. A coating liquid to be the curing agent 12 is supplied to the central flow path 32. The viscosity of the curing agent 12 is higher than the viscosity of the main agent 14. Specific gravity of the curing agent 12 is higher than specific gravity of the main agent 14. The main agent 14 is supplied so that a flow rate (the volume of the agent flowing per unit time) of the main agent 14 is higher than a flow rate of the curing agent 12. The flow paths through which the main agent 14 and the curing agent 12 pass may be reversed.

The central flow path 32 is formed so that a central axis thereof extends along a central axis of the supply tube 30. The central flow path 32 has an outlet that is open downstream in a flow direction. In the present embodiment, the central flow path 32 is formed to have a circular cross-section perpendicular to the central axis.

The annular flow path 34 is located radially outward of the central flow path 32. The annular flow path 34 is formed so that a central axis thereof extends along the central axis of the supply tube 30. The annular flow path 34 has an outlet that is open downstream in the flow direction. In this example, the annular flow path 34 is formed to surround the central flow path 32. The annular flow path 34 is annularly formed to fully circumferentially cover the central flow path 32. More specifically, the annular flow path 34 is annularly formed to be centered at the central axis of the central conduit. That is to say, the central flow path and the annular flow path are formed to be concentric with each other.

The supply tube 30 as described above can be formed by a combination of two tubes. For example, a spacer member to position a central tube at a fixed location relative to an outer tube may be interposed between the central tube and the outer tube. A state of the annular flow path 34 being formed around the central flow path 32 may be maintained as described above. A communication path to communicate the flow paths of the supply tube is not formed, and the curing agent 12 and the main agent 14 flowing respectively through the central flow path and the annular flow path flow from an inlet to the outlet without being mixed in the supply tube 30.

The cross-section perpendicular to the axis of the central flow path 32 may not be circular, and may be elliptical or polygonal, for example. The annular flow path 34 may not have a circular annular cross-section, and may have an elliptical annular cross-section or a polygonal annular cross-section. The shape and the size of each of the flow path 32 and the flow path 34 may differ at the inlet and at the outlet of the supply tube 30.

The mixing nozzle 40 communicates with the outlet of the supply tube 30. The mixing nozzle 40 is in the form of a tube that is open at opposite ends along an axis. An inlet of the mixing nozzle 40 is connected to the outlet of the supply tube 30. An outlet of the mixing nozzle 40 is located downstream from the outlet of the supply tube 30 in the flow direction. The majority of an interior space 42 of the mixing nozzle 40 is thus disposed downstream from the supply tube 30 in the flow direction of the coating liquids. Specifically, the mixing nozzle 40 is shaped to cover the outlet of the annular flow path 34. The outlet of the central flow path 32 and the outlet of the annular flow path 34 are open to the interior space of the mixing nozzle 40. The curing agent 12 and the main agent 14 having passed respectively through the flow path 32 and the flow path 34 thus join together in the interior space 42 of the mixing nozzle 40. The mixing nozzle 40 in this example is in the form of a cylindrical tube coaxial with the supply tube 30. In other words, the interior space 42 of the mixing nozzle 40 is formed to be coaxial with the central flow path 32 and the annular flow path 34.

The mixing nozzle 40 includes a reduced diameter portion gradually narrowing toward the outlet. Specifically, the mixing nozzle 40 includes, in addition to the reduced diameter portion, a connection portion connected to the supply tube 30 and an ejection portion in which a jet is formed. The connection portion, the reduced diameter portion, and the ejection portion of the mixing nozzle 40 are arranged along the axis from an upstream side to a downstream side in the flow direction. In this example, the connection portion is connected to the supply tube 30 by being fit onto the supply tube 30 from radially outside the supply tube 30. The connection portion communicates with the reduced diameter portion on a side downstream in the flow direction. The reduced diameter portion communicates with the ejection portion on a side downstream in the flow direction. In this example, the ejection portion is in the form of a cylindrical tube having a uniform diameter along the axis.

As illustrated in FIG. 2, the interior space 42 of the mixing nozzle 40 is formed so that an open area S4 at an outlet at which the jet is formed is smaller than a total open area S1 of the flow path 32 and the flow path 34 (S4<S1). Specifically, the interior space 42 is shaped to have a cross-sectional area gradually reduced toward the jet to be the outlet by the reduced diameter portion. In the present embodiment, the total open area S1 of the flow path 32 and the flow path 34 is the sum of an open area S2 at the outlet of the central flow path 32 and an open area S3 at the outlet of the annular flow path 34. The interior space 42 herein includes a proximal end side space 43, an intermediate space 44, and a distal end side space 45.

The proximal end side space 43 is in the form of a cylinder having an outer diameter greater than an outer diameter of the annular flow path 34. Herein, the outer diameter of the proximal end side space 43 is set to be the same as an outer diameter of the supply tube 30, and the proximal end side space 43 extends further downstream from an end at the outlet of the supply tube 30 in the flow direction. The distal end side space 45 is formed in a portion of a cylindrical space having a smaller outer diameter than the proximal end side space 43. The open area S4 at a distal end in the distal end side space 45 is smaller than the above-mentioned total area S1. In the present embodiment, the area S4 in the distal end side space 45 is set to be smaller than the open area S2 of the central flow path 32. The central flow path 32 may have a greater cross-sectional area (cross-sectional area along the axis) than the annular flow path 34 at an outer periphery of the central flow path 32.

The intermediate space 44 is shaped to be gradually reduced from the proximal end side space 43 toward the distal end side space 45. The intermediate space 44 is herein shaped to have an outer diameter continuously reduced from the proximal end side space 43 toward the distal end side space 45. In other words, the intermediate space 44 is formed in a space in the form of a truncated cone obtained by cutting off the top of a cone.

The mixing nozzle 40 as described above may be formed by ductile deformation or cutting of a metal tube. In this example, the mixing nozzle 40 is formed to have an outer shape corresponding to the above-mentioned interior space 42. The mixing nozzle 40 is only required to have the above-mentioned interior space 42 therein, and the outer shape of the mixing nozzle 40 is not particularly limited.

In the present embodiment, the supply tube 30 and the mixing nozzle 40 are formed to be separate from each other. The outer diameter at a distal end of the supply tube 30 and an inner diameter at a proximal end of the mixing nozzle 40 are set so that the proximal end of the mixing nozzle 40 can be fit onto the distal end of the supply tube 30. The proximal end of the mixing nozzle 40 can thus be fit onto the distal end of the supply tube 30, so that the mixing nozzle 40 has an attachment structure removably attached to the supply tube 30. The structure in which the mixing nozzle 40 is removably attached to the supply tube 30 may be a structure in which one of the distal end of the supply tube and the proximal end of the mixing nozzle is press fit into the other one of the distal end of the supply tube and the proximal end of the mixing nozzle. The connection portion in which the supply tube and the mixing nozzle are connected may have a structure to prevent removal to maintain the connection, for example. For example, the mixing nozzle is removably attached to the supply tube by a fastening member, such as a bolt member and a clamp member. The attachment structure may be a structure in which the distal end of the supply tube and the proximal end of the mixing nozzle have engaging threads, and they engage with each other. Alternatively, the attachment structure may be a structure in which a screw threaded into the mixing nozzle is pressed against an outer periphery of the supply tube 30 or a structure in which a hook structure provided to one of the supply tube 30 and the mixing nozzle 40 is caught by the other one of the supply tube 30 and the mixing nozzle 40.

A structure to supply the curing agent 12 and the main agent 14 respectively to the flow path 32 and the flow path 34 will be described. A curing agent supply source 60 and the proximal end of the supply tube 30 are communicatively connected through a curing agent supply 61. A conduit in the curing agent supply 61 and the central flow path 32 communicate with each other. The curing agent supply source 60 is a tank storing the curing agent 12 as a coating liquid 12. A curing agent pump 62 is disposed along the curing agent supply 61.

Due to driving of the curing agent pump 62, the curing agent 12 stored in the curing agent supply source 60 is supplied toward the central flow path 32. A flow velocity (pressure) of the curing agent 12 flowing through the central flow path 32 is adjusted through control of driving of the curing agent pump 62.

A main agent supply source 66 and the proximal end of the supply tube 30 are communicatively connected through a main agent supply 67. A conduit in the main agent supply 67 and the annular flow path 34 communicate with each other. The main agent supply source 66 is a tank storing the main agent 14 as a coating liquid 14. A main agent pump 68 is disposed along the main agent supply 67. Due to driving of the main agent pump 68, the main agent 14 stored in the main agent supply source 66 is supplied toward the annular flow path 34. A flow velocity (pressure) of the main agent 14 flowing through the annular flow path 34 is adjusted through control of operation of the main agent pump 68. The above-mentioned pumps 62 and 68 are connected to a control unit 16. The control unit 16 includes a computer including a central processing unit (CPU), a main storage, an auxiliary storage, and the like. The control unit 16 operates according to a program stored in the auxiliary storage and the like to control operation of the pumps 62 and 68. On and off of supply of the curing agent 12 and the main agent 14 respectively to the flow path 32 and the flow path 34, the flow velocities on the flow paths 32 and 34, and the like are thus adjusted. On and off of supply of the curing agent 12 and the main agent 14 respectively to the flow path 32 and the flow path 34, the flow velocities on the flow paths 32 and 34, and the like may be adjusted through control of driving of electromagnetic regulator valves and the like provided to the supplies 61 and 67.

The main agent supplied to the annular flow path may be switched so that different main agents can be supplied. In this case, the tank and the main agent supply are provided for each of the different main agents, and a switching device to switch a supply path is provided. The control unit controls the switching device to switch the main agent supplied to the supply tube. The control device thus allows for supply of different main agents depending on the coating target.

A coating liquid mixing method will be described. The coating liquid mixing method includes (a) a preparation step of preparing the supply tube 30 and the mixing nozzle 40 described above and (b) a supply step of supplying, after the preparation step, the curing agent 12 and the main agent 14 respectively to the flow path 32 and the flow path 34 of the supply tube 30, and mixing the curing agent 12 and the main agent 14 from the outlet of the supply tube 30 in the interior space 42 of the mixing nozzle 40.

The interior space 42 of the mixing nozzle 40 is a space in which the curing agent 12 and the main agent 14 are mixed, and is thus one example of a mixing space. The interior space 42 includes a reduced diameter portion narrowing toward the outlet. Thus, the curing agent 12 and the main agent 14 are guided to be mixed together while increasing in flow velocity in the interior space 42 of the mixing nozzle 40. By deflecting the curing agent 12 and the main agent 14 as described above, the curing agent 12 and the main agent 14 can be mixed together. Due to so-called shear mixing as described above, a region where the coating liquids have a minimum flow velocity can be prevented compared with a case where a baffle for agitation is provided to the supply. Clogging of the nozzle with the coating liquids can thus be prevented. Maintainability can be improved due to reduction of work to eliminate clogging with the coating liquids. In the present embodiment, clogging with the coating liquids can be prevented as described above, so that, in addition to reduction of a work step, the quantity of a cleaning agent used to eliminate clogging with the coating liquids can be reduced. Waste liquid treatment of the cleaning agent can thus be reduced, leading to reduction in cost of the waste liquid treatment and load on an environment. Shear mixing herein refers to mixing while shearing force is mainly applied to each of the coating liquids.

In the present embodiment, the flow rate (volume of the agent flowing per unit time) of the main agent 14 flowing through the annular flow path 34 is set to be higher than the flow rate of the curing agent 12 flowing through the central flow path 32. The flow velocity of the main agent 14 flowing through the annular flow path 34 may be set to be higher than the flow velocity of the curing agent 12 flowing through the central flow path 32. The flow velocity herein refers to the flow velocity at the outlet of each of the central flow path 32 and the annular flow path 34. The flow rate or the flow velocity as described above may be set through control of driving of each of the above-mentioned pumps 62 and 68 and the like in view of the area of each of the central flow path 32 and the annular flow path 34.

The main agent 14 is supplied from the annular flow path 34 toward a radially outward region in the interior space 42. As described above, an inner peripheral wall surrounding the main agent 14 supplied from the annular flow path 34 narrows in the interior space 42. The inner peripheral wall in the interior space 42 thus deflects the main agent 14 to a radially inward region, and increases the flow velocity of the main agent 14. This makes the main agent 14 more likely to move toward the curing agent 12 flowing through the radially inward region, and to be mixed with the curing agent 12. In other words, the increase in flow velocity (flow rate) of the main agent 14 facilitates creation of a flow of the main agent 14 entering into the radially inward region in the interior space 42, and can further promote the so-called shear mixing. The flow velocity (or the flow rate) of the curing agent 12 flowing through the central flow path 32 may be set to be the same as or higher than the flow velocity (or the flow rate) of the main agent 14 flowing through the annular flow path 34.

In the present embodiment, the viscosity of the main agent 14 flowing through the annular flow path 34 is set to be lower than the viscosity of the curing agent 12 flowing through the central flow path 32. Such setting may be achieved by making setting so that the viscosity of the curing agent 12 stored in the curing agent supply source 60 is higher than the viscosity of the main agent 14 stored in the main agent supply source 66.

By making setting so that the viscosity of the main agent 14 flowing through the annular flow path 34 is lower as described above, the main agent 14 flowing through the radially outward region in the interior space 42 is easily deflected. This facilitates movement of the main agent 14 flowing through the radially outward region toward the radially inward region and creation of the flow of the main agent 14 entering into the radially inward region from the radially outward region in the interior space 42, and can further promote the so-called shear mixing. The viscosity of the curing agent 12 flowing through the central flow path 32 may be set to be the same as or higher than the viscosity of the main agent 14 flowing through the annular flow path 34.

According to the coating liquid mixing device 20 and the coating liquid mixing method described above, the different coating liquids 12 and 14 can be mixed as described above. In the present embodiment, the mixture 15 discharged by the mixing nozzle 40 reaches the residence space 163 in the bell cup 160, and is further agitated in the bell cup 160. Mixing before reaching the coating target can thus be further enhanced. In other words, mixing can be performed both in the bell cup 160 and in the mixing nozzle 40, so that a degree of mixing before reaching the coating target can be improved compared with a case where mixing is performed only in the mixing nozzle 40.

The interior space of the mixing nozzle 40 may be formed in the intermediate space 44 shaped to be gradually continuously reduced toward the distal end side space 45. In this case, a corner to which the curing agent 12 and the main agent 14 are likely to adhere can be suppressed. Furthermore, even if the curing agent 12 and the main agent 14 adhere to the inner peripheral wall of the mixing nozzle 40, the adhering agents are easily cleaned with a cleaning liquid due to prevention of any irregularity in the inner peripheral surface. The mixing nozzle 40 is easily cleaned, for example, and thus has high maintainability. Although the interior space is in the form of the truncated cone in the present embodiment, the interior space may have any other cross-sectional shapes along the axis. For example, the inner peripheral surface may extend curvilinearly, for example, parabolically, and may gradually be reduced in diameter toward the outlet.

The annular flow path 34 may annularly be formed to circumferentially surround the central flow path 32. In this case, the main agent 14 supplied from the annular flow path 34 to the mixing nozzle 40 can be guided from a region fully circumferentially provided around the central axis toward the central axis of the mixing nozzle 40. A lack of circumferential balance of a degree of mixing can thus be suppressed. The curing agent 12 and the main agent 14 can thus more suitably be mixed.

The mixing nozzle 40 may be shaped to be removably attached to the supply tube 30.

In this case, the mixing nozzle 40 can be removed from the supply tube 30 for cleaning. The main agent 14 and the curing agent 12 are mixed in the mixing nozzle 40, and are thus more likely to adhere to the mixing nozzle 40 than to the upstream portion due to curing. By removing the portion, a portion to which the main agent 14 and the curing agent 12 adhere can more intensively be cleaned compared with a case where the portion is cleaned along with the supply tube 30. The coating liquid mixing device 20 has high maintainability from this perspective. Furthermore, the mixing nozzle 40 is connected to a downstream end (the distal end) to be a downstream outlet of the supply tube 30 in the present embodiment. The mixing nozzle 40 is thus more accessible from a downstream side on which the bell cup 160 is located compared with a case where the mixing nozzle 40 is disposed upstream from the supply tube 30. The mixing nozzle 40 is thus easily removed and attached, leading to reduction in time required to remove the mixing nozzle 40 for cleaning.

The mixing nozzle 40 may be formed so that the open area S4 at the distal end in the interior space 42 is smaller than the total open area S1 of the flow path 32 and the flow path 34 (S4<S1). In this case, the flow velocity of the curing agent 12 and the main agent 14 discharged from the mixing nozzle 40 can be higher than the flow velocity of the curing agent 12 and the main agent 14 flowing through the supply tube. Such reduction in open area at the distal end can promote mixing in the mixing space, and enhance the degree of mixing of the curing agent 12 and the main agent 14. Since the open area in a region upstream from the outlet of the mixing nozzle 40 is smaller than the total open area S1 of the flow path 32 and the flow path 34, the flow velocity of the curing agent 12 and the main agent 14 can be increased before discharge, and the degree of mixing can further be enhanced.

The open area S2 of the central flow path 32 may be greater than the area S4 at the outlet of the mixing nozzle 40. In this case, mixing in the mixing space can further be promoted by further reducing the area S4. The flow velocity of the curing agent 12 and the main agent 14 is increased in the mixing nozzle 40. Mixing of the curing agent 12 and the main agent 14 can thus further be promoted.

The mixing device 20 may include an outer peripheral flow path 136 at an outer periphery of the flow path 32 and the flow path 34. For example, an outer tube 132 is disposed around the supply tube 30. The outer peripheral flow path 136 is annularly formed between the supply tube 30 and the outer tube 132. The outer peripheral flow path 136 may not necessarily annularly be formed, and may be in the form of a hole.

An opening of the outer peripheral flow path 136 is open to an outer periphery of the mixing nozzle 40. An opening of the outer tube 132 may be open at a location upstream from the opening of the mixing nozzle 40. More specifically, the outer tube 132 is disposed to be spaced away from an outer peripheral surface of the supply tube 30. The mixing nozzle 40 covers the distal end of the supply tube 30. There is a gap between an outer peripheral surface at the proximal end of the mixing nozzle 40 and the outer tube 132. An opening between the outer peripheral surface of the supply tube 30 and the outer tube 132 is open to the outer periphery of the mixing nozzle 40. A distal end of the outer tube 132 is located upstream from the opening of the mixing nozzle 40. The opening of the outer peripheral flow path 136 is thus located upstream from the opening of the mixing nozzle 40. The outer peripheral flow path 136 is herein open at a location upstream from the bell cup 160.

The cleaning liquid in a cleaning liquid supply source 71 is supplied by a pump 73 to the outer peripheral flow path 136 through a cleaning liquid supply 72. As the cleaning liquid, a cleaning liquid in which the curing agent 12 and the main agent 14 are easily dissolved is selected depending on the types of the agents.

When the outer peripheral flow path 136 is provided as described above, the outer periphery and the distal end of the mixing nozzle 40 can be cleaned by allowing a cleaning liquid 112 to flow through the outer peripheral flow path 136. In this case, the outer peripheral flow path 136 reaches the distal end of the mixing nozzle 40 through the outer periphery of the mixing nozzle 40, and is thus less likely to reach the openings of the flow path 32 and the flow path 34. The cleaning liquid 112 is thus less likely to be mixed with the curing agent 12 and the main agent 14 supplied respectively from the flow path 32 and the flow path 34, and the mixture 15 can stably be manufactured.

{Modifications}

Although an example in which the mixing device 20 is used for the coating device including the bell cup 160 has been shown in the present embodiment, the present invention is not limited to the example. That is to say, the mixing device 20 is applicable to a device that atomizes coating liquids mixed using a means other than the bell cup 160. For example, a similar effect can be obtained when the mixing device according to the present invention is used for a discharge portion of a spray gun that discharges a coating liquid included in compressed air.

Although an example in which the open area S2 of the central flow path 32 is greater than the area S4 at the outlet of the mixing nozzle 40 has been described in the present embodiment, the open area S2 of the central flow path 32 may be the same as or smaller than the area S4 at the outlet of the mixing nozzle 40.

Although the mixing nozzle 40 is removably attached to the supply tube 30 in the present embodiment, the mixing nozzle 40 may not necessarily be removably attached to the supply tube 30, and a case where the mixing nozzle and the supply tube are integrally formed is also included in the present invention. When they are integrally formed, an outer diameter at the outlet of the annular flow path and an outer diameter at the inlet of the mixing nozzle are likely to be formed to have the same shape. The coating liquid can thus be allowed to flow smoothly from the annular flow path to the mixing nozzle.

In the above-mentioned embodiment, the flow paths may not necessarily include the central flow path 32 and the annular flow path 34. For example, the flow paths may be flow paths in the form of holes formed in parallel. Alternatively, the flow paths may include the central flow path 32 and an outer flow path located radially outward of the central flow path, for example. The outer flow path may include outer flow paths circumferentially arranged around the central flow path. For example, main agents differing in component may be supplied to the respective outer flow paths. Although an annular path through which the cleaning liquid flows is formed radially outward of the annular flow path in the present embodiment, a case where such an annular path is not formed is also included in the present invention.

Although the reduced diameter portion has a structure in which the open area is gradually continuously reduced toward the outlet in the present embodiment, the reduced diameter portion may have a stepped profile like a flight of stairs. A case where the central flow path and the annular flow path are formed to be non-concentric with each other is also included in the present invention. The mixing nozzle is preferably attached to the downstream end of the supply tube, but a case where the mixing nozzle is attached to another portion may also be included in the present invention. Although the supply conduit and the mixing nozzle have been described to rotate along with the bell cup in the coating device, for example, they may be provided not to rotate with respect to the bell cup, and a case where they are provided at a location away from the bell cup is also included in the present invention, for example. The flow velocity of, the flow rate of, the viscosity of, a substance contained in, and a material for the coating liquid flowing through each of the flow paths are not limited to those in the present embodiment, and a case where another setting is used is also included in the present invention.

The structure in which the supply tube 30 and the mixing nozzle 40 are removably attached to each other is not limited to that in the above-mentioned example. For example, in a state of the distal end of the supply tube 30 and the proximal end of the mixing nozzle 40 being arranged to oppose each other, a flange around them may be screwed. The mixing nozzle 40 may not necessarily be formed to be separate from the supply tube 30. The mixing nozzle 40 and the supply tube 30 may integrally be formed.

In the mixing nozzle, the space gradually reduced toward the distal end may be present in an intermediate portion along a direction of extension of the mixing nozzle 40 as in the above-mentioned embodiment, may be present in a region reaching the distal end of the mixing nozzle, may be present on a side of the proximal end, and may be present in a region along the direction of extension of the mixing nozzle as a whole. This means that the gradually reduced space in the mixing nozzle is only required to be present at least partially along the direction of extension of the mixing nozzle. The intermediate space 44 may not necessarily be shaped to be gradually reduced toward the distal end. The mixing nozzle may be shaped to narrow toward the distal end through steps as described above.

When three or more coating liquids are mixed, the supply tube may include three or more flow paths. In this case, annular flow paths may be formed to be concentric around the central flow path as described above.

In the embodiment, the mixing nozzle 40 may cover an outer periphery of the outer peripheral flow path 136 to allow the cleaning liquid to pass through the interior of the mixing nozzle 40. In this case, the interior of the mixing nozzle 40 can be cleaned.

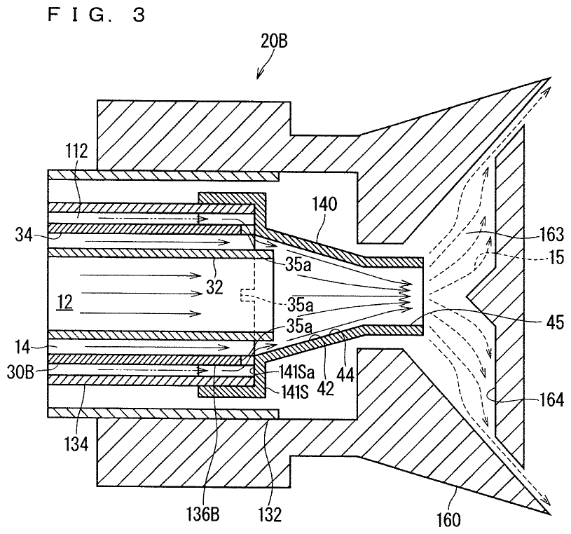

FIG. 3 illustrates a coating liquid mixing device 20B according to a modification.

As illustrated in FIG. 3, a tube 134 is added inside the outer tube 132. A mixing nozzle 140 corresponding to the mixing nozzle 40 is mounted on a distal end of the tube 134. In the present modification, the mixing nozzle 140 is fit onto the distal end of the tube 134. There is a gap between an inner peripheral surface of the outer tube 132 and an outer peripheral surface of the tube 134, and there is also a gap between the inner peripheral surface of the outer tube 132 and an outer periphery at a proximal end of the mixing nozzle 140. In a state of rotation of the tube 134, the mixing nozzle 140, and parts inside them being stopped, the outer tube 132 and the bell cup 160 are rotatably driven by a rotational drive unit, such as a motor.

The tube 134 covers an outer periphery of a supply tube 30B corresponding to the supply tube 30 with a gap therebetween. The cleaning liquid is supplied to the mixing nozzle 140 through a gap in an annular flow path 136B between the supply tube 30B and the tube 134, and is discharged outward from the mixing nozzle 140. Since the cleaning liquid passes through the interior of the mixing nozzle 140, the interior of the mixing nozzle 140 can be cleaned with the cleaning liquid.

In this case, an annular edge of an outermost periphery at the distal end of the supply tube 30B corresponding to the supply tube 30 may have a recess 35a. More specifically, an annular edge of an outer periphery of the supply tube 30B (herein an edge at an open end of a tube defining an outer periphery of the annular flow path 34) has the recess 35a. The recess 35a is in the form of a cut recessed from the distal end toward the proximal end of the supply tube 30B, for example. The recess 35a may be a square recess, may be a slit-like recess having the length along the axis of the supply tube 30B, and may be a semicircular or triangular recess. The recess 35a may include a single recess 35a or two or more recesses 35a formed in the annular edge at the distal end of the supply tube 30B. The recess 35a may have any depth (the length along the axis of the supply tube 30B) and any width (the length along the circumference of the supply tube 30B), and, for example, may have a size of approximately ¼ to ⅔ of a diameter of the central flow path 32.

The proximal end of the mixing nozzle 140 is shaped to expand radially outward through a step 141S. In a state of the proximal end of the mixing nozzle 140 being fit onto the distal end of the tube 134, an inward facing surface 141Sa of the step 141S covers an open end of the tube 134. The inward facing surface 141Sa may be in contact with the open end of the tube 134. The inward facing surface 141Sa may be located away from the open end of the tube 134.

The cleaning liquid hits against the inward facing surface 141Sa, and flows to the distal end of the annular flow path 34 through the recess 35a. In this case, a flow to a region radially inward of the annular flow path 34 is created. When the inward facing surface 141Sa is in contact with the open end of the tube 134, the cleaning liquid as a whole is more surely deflected inward through the recess 35a. This can prevent the cleaning liquid from flowing along an inner peripheral surface of the mixing nozzle 140, and can create a radially inward flow and, further, a flow swirling radially inward in the mixing nozzle 140. The cleaning liquid is thus likely to enter toward an upstream side of the annular flow path 34 through the recess 35a.

Furthermore, a total radial cross-sectional area of a flow path through which the cleaning liquid flows inward from the flow path 136B (a total radial cross-sectional area of the tube 30B at the recess 35a in a case where the inward facing surface 141Sa is in contact with the open end of the tube 134) is smaller than a cross-sectional area of a flow path through which the cleaning liquid passes (a cross-sectional area perpendicular to the axis of the tube 134 of a gap between the tube 134 and the supply tube 30B). The flow velocity of the cleaning liquid passing through the recess 35a can thus be higher than the flow velocity of the cleaning liquid flowing at a location upstream from the recess 35a.

A cleaning effect can be enhanced by providing the recess 35a as one example of a guide to guide the cleaning liquid to a region radially inward of a slope of the mixing nozzle 140 as described above.

In the present embodiment, the proximal end of the mixing nozzle 140 completely covers an open end of the supply tube 30B forming an inner partition of a path through the cleaning liquid flows. The proximal end of the mixing nozzle 140 may partially cover or may not cover the open end of the supply tube 30B.

The recess 35a is only required to be shaped to radially penetrate the supply tube 30B, and the shape thereof is not particularly limited. The guide to guide the cleaning liquid inward of the mixing nozzle 140 may not necessarily be the recess radially penetrating the supply tube 30B. For example, the inward facing surface 141Sa itself may be the guide to guide the cleaning liquid inward of the mixing nozzle 140, and, in this case, the recess 35a may be omitted. Alternatively, a guide flow path to guide the cleaning liquid inward of the mixing nozzle 140 due to a combination of irregularities may be formed between the outer periphery at the distal end of the supply tube and the inward facing surface 141Sa.

A case where only two-liquid mixing coating is performed without allowing the cleaning liquid to flow is also included in the present invention.

Configurations described in the above-mentioned embodiment and modifications can be combined with each other as appropriate unless any contradiction occurs.

While the present invention has been described in detail, the foregoing description is in all aspects illustrative and not restrictive. It is understood that numerous unillustrated modifications can be devised without departing from the scope of the present invention.

As described above, the present application includes the following aspects.

A first aspect is a coating liquid mixing device including: a supply tube including flow paths through which respective coating liquids flow and which are distally open; and a mixing nozzle communicating with an outlet of the supply tube so that the coating liquids flowing through the flow paths are supplied to an interior space, and including a reduced diameter portion in which the interior space is reduced toward an outlet so that an open area of the mixing nozzle is smaller than a total open area of the flow paths.

The mixing device includes the mixing nozzle having the interior space shaped to be reduced toward the outlet so that the open area of the mixing nozzle is smaller than the total open area of the flow paths. Thus, when the coating liquids are supplied from the respective flow paths to the mixing nozzle, the coating liquids are guided to be mixed together while increasing in flow velocity in the interior space of the mixing nozzle. By deflecting the coating liquids as described above, the coating liquids can be mixed together. By deflecting the coating liquids flowing through the nozzle for mixing as described above, a region where the coating liquids have a minimum flow velocity can be prevented compared with a case where the baffle for agitation is provided. Clogging of the nozzle with the coating liquids can thus be prevented. Maintainability can be improved due to reduction of work to eliminate clogging with the coating liquids.

A second aspect is the coating liquid mixing device according to the first aspect, wherein the reduced diameter portion is shaped so that an open area is gradually continuously reduced toward the outlet. In this case, a corner to which the coating liquids are likely to adhere can be suppressed. Furthermore, even if the coating liquids adhere to the inner peripheral wall of the mixing nozzle, the adhering coating liquids are easily cleaned with the cleaning liquid due to prevention of any irregularity in the inner peripheral surface. The mixing nozzle is easily cleaned, for example, and thus has high maintainability.

A third aspect is the coating liquid mixing device according to the first or second aspect, wherein the flow paths include a central flow path and an annular flow path circumferentially surrounding the central flow path. The coating liquid supplied from the annular flow path to the mixing nozzle can thus be guided from a region fully circumferentially provided around the central axis toward the central axis of the mixing nozzle. A lack of circumferential balance of a degree of mixing can thus be suppressed. The coating liquids can thus more suitably be mixed.

A fourth aspect is the coating liquid mixing device according to any one of the first to third aspects, wherein the mixing nozzle is shaped to be removably attached to the supply tube. The mixing nozzle can thus be removed from the supply tube for cleaning. The coating liquid mixing device has high maintainability from this perspective.

A fifth aspect is the coating liquid mixing device according to any one of the first to fourth aspects, wherein the mixing nozzle is attached to a downstream end of the supply tube. The mixing nozzle is thus more accessible from a downstream side compared with a case where the mixing nozzle is disposed upstream from the supply tube. The mixing nozzle is thus easily removed and attached, leading to reduction in time required to remove the mixing nozzle for cleaning.

A sixth aspect is the coating liquid mixing device according to any one of the first to fifth aspects, wherein the flow paths include a central flow path located in a center of the supply tube and an outer flow path located radially outward of the central flow path, and an open area at the outlet of the mixing nozzle is smaller than an open area at an outlet of the central flow path. Mixing in the mixing space can further be promoted by further reducing the area of the mixing nozzle. The flow velocity of the coating liquids is increased in the mixing nozzle. Mixing of the coating liquids can thus further be promoted.

A seventh aspect is the coating liquid mixing device according to any one of the first to sixth aspects, wherein the coating liquid mixing device is provided with a rotating member forming a residence space in which a coating liquid ejected from the mixing nozzle resides, and discharging the coating liquid residing in the residence space radially outward by centrifugal force due to rotation. In this case, the liquid discharged by the mixing nozzle reaches the residence space in the bell cup, and is further agitated in the bell cup. Mixing before reaching the coating target can thus be further enhanced.

An eighth aspect is the coating liquid mixing device according to any one of the first to seventh aspects, further including a tube covering an outer periphery of the supply tube, and communicating with the mixing nozzle, wherein a cleaning liquid flow path is located between the supply tube and the tube, the cleaning liquid flow path allowing a cleaning liquid to pass between the supply tube and the tube and to be supplied to the interior space of the mixing nozzle. The interior of the mixing nozzle can thus be cleaned with the cleaning liquid.

A coating liquid mixing method according to a ninth aspect is a coating liquid mixing method including: (a) a preparation step of preparing a supply tube and a mixing nozzle, the supply tube including flow paths through which respective coating liquids flow and which are distally open, the mixing nozzle communicating with an outlet of the supply tube so that the coating liquids flowing through the flow paths are supplied to an interior space, and including a reduced diameter portion in which the interior space is gradually reduced toward an outlet so that an open area of the mixing nozzle is smaller than a total open area of the flow paths; and (b) a supply step of supplying, after the preparation step, the coating liquids to the respective flow paths of the supply tube, and mixing the coating liquids from the outlet of the supply tube in the interior space of the mixing nozzle.

According to the coating liquid mixing method, the above-mentioned mixing nozzle is prepared, and, in the supply step, the coating liquids are mixed using the mixing nozzle. Clogging of the nozzle with the coating liquids can thus be prevented to improve maintainability as described above.

A tenth aspect is the coating liquid mixing method according to the ninth aspect, wherein the flow paths of the supply tube prepared in the preparation step (a) include a central flow path and an annular flow path circumferentially surrounding the central flow path, and, in the supply step (b), different coating liquids are supplied to the central flow path and the annular flow path, and a flow velocity of a coating liquid flowing through the annular flow path is set to be higher than a flow velocity of a coating liquid flowing through the central flow path. An inner peripheral wall surrounding the coating liquid supplied from the annular flow path narrows in the interior space of the mixing nozzle. The inner peripheral wall in the interior space thus deflects the coating liquid to a radially inward region, and increases the flow velocity of the coating liquid. This makes the coating liquid supplied from the annular flow path more likely to move toward the coating liquid supplied from the central flow path to facilitate mixing of the coating liquids.

An eleventh aspect is the coating liquid mixing method according to the ninth or tenth aspect, wherein the flow paths of the supply tube prepared in the preparation step (a) include a central flow path and an annular flow path circumferentially surrounding the central flow path, and, in the supply step (b), a viscosity of a coating liquid supplied to the annular flow path is set to be lower than a viscosity of a coating liquid supplied to the central flow path. The coating liquid flowing through the radially outward region in the interior space of the mixing nozzle is thus easily deflected. This facilitates movement of the coating liquid flowing through the radially outward region toward the radially inward region and creation of the flow of the coating liquid entering into the radially inward region from the radially outward region in the interior space, and can further promote the so-called shear mixing.

A twelfth aspect is the coating liquid mixing method according to any one of the ninth to eleventh aspect, wherein the flow paths of the supply tube prepared in the preparation step (a) include a central flow path and an annular flow path circumferentially surrounding the central flow path, and, in the supply step (b), a coating liquid to be a main agent is supplied to the annular flow path, and a curing agent to cure the main agent is supplied to the central flow path. The coating liquid to be the main agent is deflected to the radially inward region in the interior space of the mixing nozzle while increasing in flow velocity. This makes the main agent more likely to move toward the curing agent flowing through the radially inward region, and to be mixed with the curing agent.

### EXPLANATION OF REFERENCE SIGNS

12 curing agent (coating liquid)
14 main agent (coating liquid)
20, 20B coating liquid mixing device
30 supply tube
32 central flow path
34 annular flow path
40 mixing nozzle
42 interior space
134 tube
160 bell cup
163 residence space
S1 total open area
S2 open area of central flow path
S3 open area of annular flow path
S4 open area of mixing nozzle

1. A coating liquid mixing device comprising:
a supply tube including flow paths through which respective coating liquids flow, the flow paths being distally open; and
a mixing nozzle communicating with an outlet of the supply tube so that the coating liquids flowing through the flow paths are supplied to an interior space, the mixing nozzle including a reduced diameter portion in which the interior space is reduced toward an outlet so that an open area of the mixing nozzle is smaller than a total open area of the flow paths.

2. The coating liquid mixing device according to claim 1, wherein
the reduced diameter portion is shaped so that an open area is gradually continuously reduced toward the outlet.

3. The coating liquid mixing device according to claim 1, wherein
the flow paths comprise a central flow path and an annular flow path circumferentially surrounding the central flow path.

4. The coating liquid mixing device according to claim 1, wherein
the mixing nozzle is shaped to be removably attached to the supply tube.

5. The coating liquid mixing device according to claim 1, wherein
the mixing nozzle is attached to a downstream end of the supply tube.

6. The coating liquid mixing device according to claim 1, wherein
the flow paths comprise a central flow path located in a center of the supply tube and an outer flow path located radially outward of the central flow path, and
an open area at the outlet of the mixing nozzle is smaller than an open area at an outlet of the central flow path.

7. The coating liquid mixing device according to claim 1, wherein
the coating liquid mixing device is provided with a rotating member forming a residence space in which a coating liquid ejected from the mixing nozzle resides, and discharging the coating liquid residing in the residence space radially outward by centrifugal force due to rotation.

8. The coating liquid mixing device according to claim 1, further comprising
a tube covering an outer periphery of the supply tube, and communicating with the mixing nozzle, wherein
a cleaning liquid flow path is located between the supply tube and the tube, the cleaning liquid flow path allowing a cleaning liquid to pass between the supply tube and the tube and to be supplied to the interior space of the mixing nozzle.

9. A coating liquid mixing method comprising:
(a) a preparation step of preparing a supply tube and a mixing nozzle, the supply tube including flow paths through which respective coating liquids flow and which are distally open, the mixing nozzle communicating with an outlet of the supply tube so that the coating liquids flowing through the flow paths are supplied to an interior space, and including a reduced diameter portion in which the interior space is gradually reduced toward an outlet so that an open area of the mixing nozzle is smaller than a total open area of the flow paths; and
(b) a supply step of supplying, after the preparation step, the coating liquids to the respective flow paths of the supply tube, and mixing the coating liquids from the outlet of the supply tube in the interior space of the mixing nozzle.

10. The coating liquid mixing method according to claim 9, wherein
the flow paths of the supply tube prepared in the preparation step (a) comprise a central flow path and an annular flow path circumferentially surrounding the central flow path, and
in the supply step (b), different coating liquids are supplied to the central flow path and the annular flow path, and a flow velocity of a coating liquid flowing through the annular flow path is set to be higher than a flow velocity of a coating liquid flowing through the central flow path.

11. The coating liquid mixing method according to claim 9, wherein
the flow paths of the supply tube prepared in the preparation step (a) comprise a central flow path and an annular flow path circumferentially surrounding the central flow path, and
in the supply step (b), a viscosity of a coating liquid supplied to the annular flow path is set to be lower than a viscosity of a coating liquid supplied to the central flow path.

12. The coating liquid mixing method according to claim 9, wherein
the flow paths of the supply tube prepared in the preparation step (a) comprise a central flow path and an annular flow path circumferentially surrounding the central flow path, and
in the supply step (b), a coating liquid to be a main agent is supplied to the annular flow path, and a curing agent to cure the main agent is supplied to the central flow path.
